(19) United States
(12) Patent Application Publication
(10) Pub. No.: US 2003/0051193 A1
(43) Pub. Date: Mar. 13, 2003

(54) Computer system with improved error detection

(75) Inventor: Manh Hung Pham, Austin, TX (US)

Correspondence Address: Roger Fulghum, Baker Botts L.L.P., One Shell Plaza, 910 Louisiana Street, Houston, TX, 77002-4995, US

(73) Assignee: Dell Products L.P.

(21) Appl. No.: 09/950,026

(22) Filed: Sep. 10, 2001

(51) Int. Cl. H04L 1/22

(52) U.S. Cl. 714/42

(57) ABSTRACT

A method of operating a computer system with a central processing unit and a memory system coupled to the central processing system. The memory system comprises a plurality of memory module slots for receiving of memory modules. Each memory module comprises a random access memory section and a non-volatile memory section. The method comprises the steps of:

detecting a memory error;

analyzing the memory error, determining a memory module in which the error occurred and creating a log; and

storing the log in the non-volatile memory section of the memory module.

### FIELD OF THE INVENTION

The invention relates generally to computer systems and in particular to modules having a non-volatile memory within computer systems and to computer systems with memory modules having a non-volatile memory section. More particularly, the invention relates to techniques for retrieving information about the failure of a module.

### BACKGROUND OF THE INVENTION

Computer memory comes in two basic forms: Random Access Memory (hereinafter RAM) and Read-Only Memory (hereinafter ROM). RAM is generally used by a processor for reading and writing data. RAM memory is volatile typically, meaning that the data stored in the memory is lost when power is removed. ROM is generally used for storing data which will never change, such as the Basic Input/Output System (hereinafter BIOS). ROM memory is non-volatile typically, meaning that the data stored in the memory is not lost even if power is removed from the memory.

Generally, RAM makes up the bulk of the computer system's memory, excluding the computer system's hard-drive, if one exists. RAM typically comes in the form of dynamic RAM (hereinafter DRAM) which requires frequent recharging or refreshing to preserve its contents. Organizationally, data is typically arranged in bytes of 8 data bits. An optional 9th bit, a parity bit, acts as a check on the correctness of the values of the other eight bits.

As computer systems become more advanced, there is an ever increasing demand for DRAM memory capacity. Consequently, DRAM memory is available in module form, in which a plurality of memory chips are placed on a small circuit card, which card then plugs into a memory socket connected to the computer motherboard or memory carrier card. Examples of commercial memory modules are SIMMs (Single In-line Memory Modules) and DIMMs (Dual In-line Memory Modules).

In addition to an ever increasing demand for DRAM capacity, different computer systems may also require different memory operating modes. Present memories are designed with different modes and operational features such as fast page mode (FPM), extended data out (EDO), synchronous DRAM (SDRAM), double data rate SDRAM (DDR SDRAM), parity and non-parity, error correcting (ECC) and non error correcting, to name a few. Memories also are produced with a variety of performance characteristics such as access speeds, refresh times and so on. Further still, a wide variety of basic memory architectures are available with different device organizations, addressing requirements and logical banks.

In order to address some of the problems associated with the wide variety of memory chip performance, operational characteristics and compatibility with system requirements, memory modules are being provided with presence detect (PD) data. PD data is stored in a non-volatile memory such as an EEPROM on the memory module. A typical PD data structure includes 256 eight bit bytes of information. Bytes 0 through 127 are generally locked by the manufacturer, while bytes 128 through 255 are available for system use. Bytes 0-35 are intended to provide an in-depth summary of the memory module architecture, allowable functions and important timing information. PD data can be read in parallel or series form, but serial PD (SPD) is already commonly in use. SPD data is serially accessed by the system memory controller during boot up across a standard serial bus such as an I.2 C™bus (referred to hereinafter as an I²C controller). The system controller then determines whether the memory module is compatible with the system requirements and if it is will complete a normal boot. If the module is not compatible an error message may be issued or other action taken.

Other modules within the system can provide similar configuration means in for of an integrated EEPROM. In particular laptop computers are built modular. Each module can have such a non-volatile memory to store module specific configuration data.

As memory modules form the main memory in a computer system their proper function is most crucial within the system. However, even with the latest technology it is not always guaranteed that a memory will have no defects. Some malfunctioning of a memory module can be related to external components, some errors might be generated within the module. Usually whenever the memory module is malfunctioning a major system error such as a system crash will take place. If the error can be reproduced the user usually contacts his service person and/or brings the computer to a service technician for repair. By telling the service person about the failure he might be able to identify the problem and exchange the respective malfunctioning part of the system. However, sometimes an error cannot be reproduced.

In yet another scenario, only the defective memory module is sent in or brought to a technician. The technician often just labels the module and sends it to a manufacturer for repair. In either case, information can get lost or can be missed. The whole process is rather cumbersome.

### SUMMARY OF THE INVENTION

Therefore, a need for an improved computer system exists. In particular a need for an improved handling of modules, in particular memory modules, within a computer system exists. One exemplary embodiment of the present invention comprises a method of operating a computer system with a central processing unit and a memory system coupled to the central processing system. The memory system comprises a plurality of memory module slots for receiving of memory modules. Each memory module comprises a random access memory section and a non-volatile memory section. The method comprises the steps of:

detecting a memory error;

analyzing the memory error, determining a memory module in which the error occurred and creating a log; and

storing the log in the non-volatile memory section of the memory module.

Another exemplary embodiment according to the present invention is a method of operating a system module comprising a non-volatile memory section. The method comprising the steps of:

detecting an error;

analyzing said error and creating a log; and

storing said log in said non-volatile memory section of said system module.

The module or memory error can be detected during a diagnostic test or during normal operation. The log can comprise information about the error type, the location of the memory module such as the slot number, the date and time when the error occurred, and/or the system identification. The log can be stored in a cyclical manner, such that the most recent error are accessible in the manner like a flight recorder works. In other words, the oldest information stored in the system or memory module will be overwritten first by new incoming data.

A computer system according an exemplary embodiment of the present invention comprises a central processing unit, a memory system coupled with the central processing unit comprising a plurality of memory module slots for receiving of memory modules. The memory module comprises a random access memory section and a non-volatile memory section. Furthermore means for detecting an error in the memory system, means for generating a log about the error, and means for storing the log in the non-volatile memory section of a memory module are provided. The means for detecting an error can be an interrupt unit generating respective exception or trap vectors if a memory access fails. The Means for generating and storing the log can be respective BIOS routines programmed for the respective central processing unit.

Yet another exemplary embodiment is a computer system comprising a central processing unit, at least one system module coupled with the central processing unit comprising a non-volatile memory section, means for detecting an error in the system module, means for generating a log about the error, and means for storing the log in the non-volatile memory section of the system module.

The non-volatile memory can be divided in a plurality of sub sections each sub section storing one log. The sub sections can be preferably written in a cyclical manner. Again, the log can comprise information about the error type, the location of the memory module, the date and time when said error occurred and information about the system identification.

### BRIEF DESCRIPTION OF THE DRAWINGS

A more complete understanding of the present disclosure and advantages thereof may be acquired by referring to the following description taken in conjunction with the accompanying drawings, in which like reference numbers indicate like features, and wherein:

FIG. 1 is a block diagram of a personal computer system according to the present invention;

FIG. 2 is a diagram showing a memory module usable for a system according to the present invention;

FIG. 3 is a flow chart according to an exemplary embodiment of the present invention;

FIG. 4 shows handling sequence after detection of an error according to an exemplary embodiment of the present invention; and

FIG. 5 shows another handling sequence for a memory module according to an exemplary embodiment of the present invention.

### DETAILED DESCRIPTION OF THE PREFERRED EMBODIMENTS

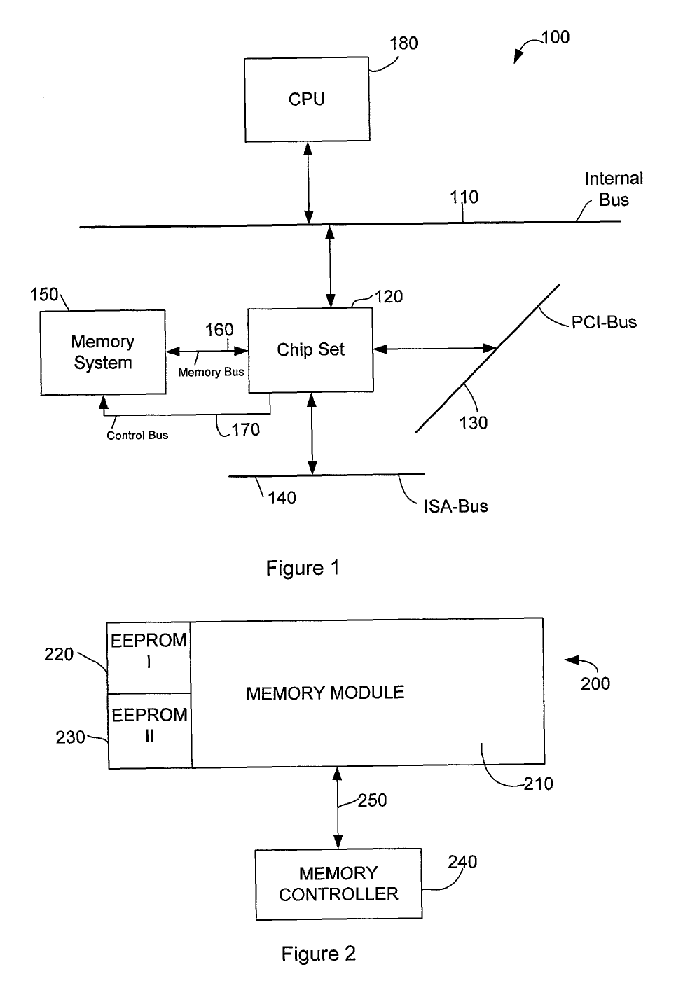

Turning to the drawings, exemplary embodiments of the present application will now be described. FIG. 1 shows a block diagram of a portable computer system 100, such as a laptop computer. The system 100 comprises a central processing unit 180 (CPU) as its central element. Connected to the CPU 180 is an internal bus 110 for coupling of peripheral elements. One or more of these peripherals is usually a chip set 120 for interfacing the memory system and extension cards, such as, PCI-, PCIX-, ISA-Bus compatible cards. Therefore, the chip set 120 provides interfaces, for example, to a PCI bus 130 and an ISA bus 140. To couple the CPU with a memory system 150, the chip set 120 provides a memory bus 160 and a control bus 170. The memory system can consist of a plurality of slots in which a user can plug in memory modules, such as DIMMs, SIMMs, etc. In this scenario the chip set 120 provides the necessary memory controller unit. In another embodiment, memory system 150 includes a memory controller which generates all necessary signals provided to the respective memory slots receiving one or more memory module.

As mentioned above, a memory module comprises the actual dynamic random access memory (DRAM) as well as a small non-volatile memory area. In another embodiment a system module, for example, a hard drive sub system can comprise a small non-volatile memory area which is mainly used for configuration purposes similar to the memory module described above. The above mentioned memory module is shown as such a system module in more detail in FIG. 2. A system module 200 is shown in form of a memory module which is divided into a main section 210 containing the actual DRAM and a non-volatile section 220, 230. Typical sizes of this DRAM area are 64 Mbytes, 128 Mbytes, 256 Mbytes, 512 Mbytes, etc. The non-volatile memory area consists of two electrical erasable programmable read only memory sections (EEPROM) 220 and 230. Memory module 200 is coupled through a bus 250 with a memory controller 240 which can be part of the memory system or the chip set 120 according to FIG. 1. Non-volatile memory bank 220 usually contains configuration information about the respective memory module or the respective system module. Bank 220 comprises 128 data bytes. The information contained in bank 220 and bank 230 for a memory module is shown in Table 1.

TABLE 1

| | |
|---|---|
| BYTE NOS. | DATA |

BANK 220

| | |
|---|---|
| 0-35 | Module functional and performance information |
| 36-61 | Superset data |
| 62 | SPD Revision |
| 63 | Checksum for bytes 0-62 |
| 64-127 | Manufacturer's information |

BANK 230

| | |
|---|---|
| 128-255 | Reserved for system use |

The PD data in bytes 0-35 can be used by a system controller to verify compatibility of the memory module 20 and the system requirements. The PD data can be read in serial or parallel format. Although serial PD data (SPD) is used in the exemplary embodiments herein, those skilled in the art will appreciate that the invention can be used with parallel PD data.

The information contained in bytes 0-127 is generally locked by the manufacturer after completion of the module build and test. This ensures that the data is not corrupted or overwritten at a later time.

In a system according to the prior art, bank 230 is usually not used for any purposes. Up to now, any malfunction of a computer system 100 causes either a respective error message on the screen or even worse will results in a freeze of the system, such that the only remedy is a reset. However, whenever a module, such as the memory system malfunctions, usually one of the memory modules or the memory controller is defect. Such a defect is usually detected by the system software, for example, the basic input output system software (BIOS). Respective error messages which are more or less descriptive will then be displayed to a user. In case of a descriptive message the user might be able to identify the problem and, for example, replace the defect system module. However, in many cases, in particular in case of a defect memory module, the malfunctioning module will be sent to the manufacturer without any additional information, for example, the information which was displayed on the screen of the respective malfunctioning computer system.

According to the present invention this information will be written into the unused memory bank 230 of the respective malfunctioning system module 200. The information may contain any type of useful information so that a technician will be able to later reconstruct what has happened in the malfunctioning system. For example, the information can contain some computer type information, the error type, the slot number in which the malfunctioning memory module was located at that time, and the date and time. Any type of memory failure information can be written into this memory bank 230, for example, in cyclical log form. The host computer 100 has access to this log to create, update or read the information via BIOS commands.

Thus, each individual failed memory module will now have individual log information that is part of the hardware. The failure information and condition will stay internally with the module permanently until it is erased or overwritten by the host computer 100, a tester or a device that can access to the non-volatile memory bank 230. The host system 100 can now use the log information to verify the condition of each memory module within each start-up routine or during a test routine. In addition, the memory module manufacturer now can use the log in complement with existing tagging systems to study the respective failure mode.

With this new concept, a computer manufacturer has the advantage of time reduction during trouble shooting and replacement of failed memory modules and a better way to document the failure on the manufacturing line. In the field, this method will help to reduce the number of unnecessary dispatches, a better diagnostic tool and a complement to the existing way to document failure at the customer site.

As can be readily seen by someone skilled in the art this method is not limited to memory modules but can be used with any other system module having a non-volatile memory section which is unused, such as a configuration memory.

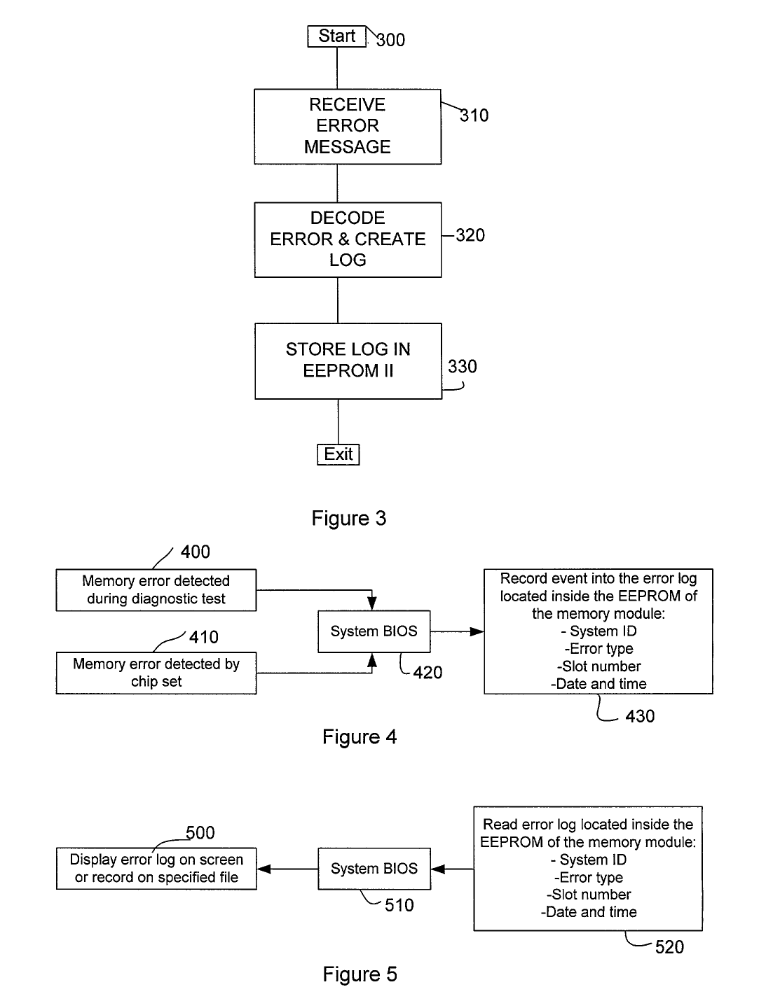

FIG. 3 shows a flow chart diagram of how the log information is written into the non-volatile memory bank. This routine can be implemented as an exception routine. A memory failure in any memory module, for example, can generate an interrupt or trap which interrupts the execution of the current instruction sequence and branches to start point 300. The generation of such an exception is usually done as follows. The CPU 180 of system 100 tries to access a specific memory location within one of the memory modules which is assumed to malfunction. As an access is not possible due to the malfunctioning, the CPU has an assigned trap or exception vector for such a memory access. The BIOS comprises a respective routine for this exception vector. In this routine the error can be documented for further use of the system software. For example, this routine can store the exact address that has been used, the data that has been tried to store, the last program counter from the stack, etc. Furthermore, the slot number of the respective memory module, and date and time the error occurred can be documented. In step 310 the routine gathers this information about the current malfunctioning. For example, the BIOS can provide a respective routine to read the specific part in the DRAM of the computer system 100 that contains the above mentioned information. In step 320 this information is decoded and transformed into the respective log information. For example, the stored address of the malfunctioning memory cell is used to determine the memory module containing the address. In addition, information about the computer, such as the CPU, model, production year etc. can be retrieved from the computer system. The transformed log information is then stored into memory bank 230 in step 330. To this end, in a first step the content of memory bank 230 is erased applying respective control signals to bank 230 of the EEPROM. In a second step the actual data is written into the bank 230 using appropriate control signals.

Depending on the size of each information log, either the whole bank 230 or only parts of it are used. To implement a cyclical log form the following procedure will be used. If, for example, 64 bits are used to document any type of error, always to consecutive error logs can be stored in memory bank 230. To this end, addresses 128-191 are used for a first log and addresses 192-255 are used for a second log. A following third log will erase and replace the first log and a fourth log will erase the second log and so on. If less information is stored within a log more logs can be permanently stored with this method according to the above described principle.

FIG. 4 shows a diagram of another embodiment according to the present invention. Box 400 indicates that an error has been detected during a diagnostic test of the computer system, for example, during a start-up routine. This error message is sent to the system BIOS 420. The second box 410 indicates that an error during normal operation has been detected by the chip set 120. Again, this error message is sent of system BIOS 420. System BIOS 420 then generates a log entry in the upper part 230 of the EEPROM of the memory module 200. The stored information can be, for example:

TABLE II

The system ID (service tag)
The error type (read error, write error, refresh
error, etc.)
The SLOT ID (location)
Date and time

Again, as described above more or less information can be generated and used to document the respective error. Each information is preferably coded to save memory space. For example, 8 bit can be used to define the error type. Thus, 256 different error types can be coded.

FIG. 5 shows a diagram for the read back routine. Box 520 contains the read error log routine initiated by system BIOS 510 which reads the respective memory module to read the information of Table II as described above. System BIOS 510 sends this information, for example to a routine 500 for displaying the error log on screen or record it on a specific file of a analyzing system.

Again, the above described method and the arrangement were described showing a computer system with memory modules having non-volatile configuration memory. However, any type of system module having a non-volatile memory section, for example, for configuration purposes, can be easily adapted to use within the scope of the present invention. For example, peripheral cards such as network, modem, disk controller etc . . . , or devices such as power supply, monitor, processor and so on can comprise non-volatile memory sections which have an unused data section. Access to these system components/modules usually is similar to the access to the memory system and can produce similar data, in particular similar error data if the respective module is malfunctioning. Using the same principle as described above, provides significant advantages to a computer manufacturer in locating the respective defect. Furthermore, statistical data can be collected which help to eliminate any type of weakness in the production which eventually might lead to a respective defect in such a module.

The invention, therefore, is well adapted to carry out the objects and attain the ends and advantages mentioned, as well as others inherent therein. While the invention has been depicted, described, and is defined by reference to exemplary embodiments of the invention, such references do not imply a limitation on the invention, and no such limitation is to be inferred. The invention is capable of considerable modification, alternation, and equivalents in form and function, as will occur to those ordinarily skilled in the pertinent arts and having the benefit of this disclosure. The depicted and described embodiments of the invention are exemplary only, and are not exhaustive of the scope of the invention. Consequently, the invention is intended to be limited only by the spirit and scope of the appended claims, giving full cognizance to equivalents in all respects.

What is claimed is:

1. Method of operating a computer system with a central processing unit and a memory system coupled to said central processing system, said memory system comprising a plurality of memory module slots for receiving of memory modules, wherein each memory module comprises a random access memory section and a non-volatile memory section, said method comprising the steps of:
detecting a memory error;
analyzing said memory error, determining a memory module in which said error occurred and creating a log; and
storing said log in said non-volatile memory section of said memory module.

2. Method according to claim 1, wherein said memory error is detected during a diagnostic test.

3. Method according to claim 1, wherein said memory error is detected during normal operation.

4. Method according to claim 1, wherein said log comprises information about the error type.

5. Method according to claim 1, wherein said log comprises information about the location of the memory module.

6. Method according to claim 1, wherein said log comprises information about the date and time when said error occurred.

7. Method according to claim 1, wherein said log comprises information about the system identification.

8. Method according to claim 1, wherein said log is stored in a cyclical manner.

9. Computer system comprising:
a central processing unit;
a memory system coupled with said central processing unit comprising a plurality of memory module slots for receiving of memory modules, said memory module comprising a random access memory section and a non-volatile memory section;
means for detecting an error in said memory system;
means for generating a log about said error; and
means for storing said log in said non-volatile memory section of a memory module.

10. Computer system according to claim 9, wherein said means for detecting an error generate an exception within said central processing unit.

11. Computer system according to claim 9, wherein said non-volatile memory is divided in a plurality of sub sections each sub section storing one log.

12. Computer system according to claim 11, wherein said sub sections are written in a cyclical manner.

13. Computer system according to claim 9, wherein said log comprises information about the error type.

14. Computer system according to claim 9, wherein said log comprises information about the location of the memory module.

15. Computer system according to claim 9, wherein said log comprises information about the date and time when said error occurred.

16. Computer system according to claim 9, wherein said log comprises information about the system identification.

17. Method of operating a module within a computer system comprising a non-volatile memory section, said method comprising the steps of:
detecting an error during an access to said module;
analyzing said error and creating a log; and
storing said log in said non-volatile memory section of said module.

18. Method according to claim 17, wherein said error is detected during a diagnostic test.

19. Method according to claim 17, wherein said error is detected during normal operation.

20. Method according to claim 17, wherein said log comprises information about the error type.

21. Method according to claim 17, wherein said log comprises information about the location of the module.

22. Method according to claim 17, wherein said log comprises information about the date and time when said error occurred.

23. Method according to claim 17, wherein said log comprises information about the system identification.

24. Method according to claim 17, wherein said log is stored in a cyclical manner.

25. Computer system comprising:
a central processing unit;
at least one system module coupled with said central processing unit comprising a non-volatile memory section;
means for detecting an error in said system module;
means for generating a log about said error; and
means for storing said log in said non-volatile memory section of said system module.

26. Computer system according to claim 25, wherein said means for detecting an error generate an exception within said central processing unit.

27. Computer system according to claim 25, wherein said non-volatile memory is divided in a plurality of sub sections each sub section storing one log.

28. Computer system according to claim 27, wherein said sub sections are written in a cyclical manner.

29. Computer system according to claim 25, wherein said log comprises information about the error type.

30. Computer system according to claim 25, wherein said log comprises information about the location of the system module.

31. Computer system according to claim 25, wherein said log comprises information about the date and time when said error occurred.

32. Computer system according to claim 25, wherein said log comprises information about the system identification.
